(19) United States
(12) Patent Application Publication
(10) Pub. No.: US 2022/0044327 A1
(43) Pub. Date: Feb. 10, 2022

(54) OPTIMIZING CONSUMPTION, CAPITAL ALLOCATION, AND ANNUITIZATION IN RETIREMENT

(71) Applicant: QS INVESTORS LLC, New York, NY (US)

(72) Inventors: Jianxiong SUN, Weehawken, NJ (US); Hongli LAN, Weehawken, NJ (US)

(21) Appl. No.: 17/430,280

(22) PCT Filed: Apr. 15, 2021
(86) PCT No.: PCT/US2021/027480

§ 371 Date: Aug. 11, 2021

Related U.S. Application Data
(60) Provisional application No. 63/010,946, filed on Apr. 16, 2020.

(51) Int. Cl. G06Q 40/06

(52) U.S. Cl. CPC G06Q 40/06; G06Q 40/08

(57) ABSTRACT

Methods, systems, and apparatus, including computer programs encoded on a computer storage medium, for optimizing consumption, capital allocation, and annuitization decisions for investors in retirement. In one aspect, a method can include obtaining a set of investor data for an investor, including (1) the investor's age, (2) the inventor's annual guaranteed income over a period T, and (3) the inventor's investment portfolio initial value. An optimal capital allocation, consumption, and annuitization for the investor over T is generated using a model and the set of investor data, by maximizing an objective function. The objective function can specify a consumption utility function and a wealth utility function. The wealth utility function can compute post-annuitization utility values for a set of ratios for each specified time interval during T and the set of ratios can be defined by normalizing different wealth values by different guaranteed income values.

### CROSS-REFERENCE TO RELATED APPLICATION

This application claims the benefit of U.S. Application Ser. No. 63/010,946, filed on Apr. 16, 2020, the entire contents of which are incorporated by reference in their entirety.

### TECHNICAL FIELD

This specification generally relates to resource efficient optimization of consumption, capital allocation, and annuitization decisions for investors.

### BACKGROUND

Retirement investing is a multi-period portfolio optimization problem where a retiree's portfolio grows by the guaranteed income each year (social security payments, annuities, etc.) and declines by consumption (expenses, leisure, healthcare costs, etc.). Deciding on the optimal capital allocation, annuitization, and consumption for an investor during retirement generally requires an analysis of the various possible levels of wealth, guaranteed income (GI), and age that the investor could experience over a certain period.

Conventionally, this optimization problem has been addressed using Dynamic Programming (DP) approaches where the capital allocation and consumption values are optimized over three dimensions, namely, the investor's wealth, guaranteed income, and age.

Conventional DP approaches generally utilize a brute force approach, which includes exhaustively searching across different combinations of the three dimensions of wealth, guaranteed income, and age, to identify optimal capital allocation and consumption values. However, because there could be a significant number of combinations of wealth, guaranteed income, and age, conventional dynamic programming-based approaches have to expend a large amount of computing resources to exhaustively analyze each possible combination. At least due to this computational complexity, conventional dynamic programming-based approaches generally only search across a subset of combinations (as opposed to every possible combination) to identify an optimal capital allocation and consumption. Also, owing at least to the computational complexity, conventional solutions generally do not perform optimization for annuitization.

### SUMMARY

This specification involves systems, software, and computer-implemented methods for optimizing consumption, capital allocation, and annuitization decisions for investors in retirement. In one aspect, a method can include the operations obtaining a set of investor data for an investor, including (1) an age of the investor, (2) an annual guaranteed income of the investor over a time period T, and (3) an initial portfolio value of an investment portfolio for the investor; generating, using a model and the set of investor data, an optimal capital allocation, an optimal consumption, and an optimal annuitization for the investor over the time period T, by maximizing an objective function, wherein: the objective function specifies (1) a consumption utility function that computes a utility derived from consumption of wealth of the investor at each specified time interval during the time period T and (2) a wealth utility function that computes utility derived from the wealth of the investor for each specified time interval during the time period T, wherein the wealth utility function computes post-annuitization utility values for a set of ratios for each specified time interval during the time period T and wherein the set of ratios is defined by normalizing different wealth values by different guaranteed income values; and providing, for display on a client device, a visualization that displays the optimal capital allocation value, the optimal consumption value, and the optimal annuitization value for the investor for each interval during the time period T. Other embodiments of this aspect include corresponding methods, apparatus, and computer programs, configured to perform the actions of the methods, encoded on computer storage devices. These and other embodiments can each optionally include one or more of the following features.

In some implementations, methods can include, for each specified time interval during the time period T: determining a total portfolio value for the investment portfolio;

determining an annuity purchase cost for purchasing an annuity and an annual annuity payment resulting from purchasing the annuity; reducing the total portfolio value by the annuity purchase cost to obtain a new total portfolio value; and generating a wealth-to-guaranteed income ratio (W/GI) using the new total portfolio value and the annual annuity payment.

In some implementations, methods can include generating wealth utility values based on the new total portfolio value; and generating the post-annuitization utility values using the wealth utility values and annual annuity payment.

In some implementations, determining the total portfolio value of the investor can include, for a time interval immediately preceding the specified time interval: determining a total income by combining a current portfolio value for the investment portfolio and a guaranteed income for the investor; generating an updated total income by reducing the total income by an amount specifying income consumed by the investor and the annuity purchase cost; generating a return for the investment portfolio; and computing the total portfolio value by multiplying the updated total income by the return for the investment portfolio.

In some implementations, generating the return for the investment portfolio for the time interval immediately preceding the specified time interval, can include generating a discretized distribution of returns for each asset class in the investment portfolio, wherein the discretized distribution of returns is generated by applying Gauss-hermite quadrature to a set of discretized points in a distribution of returns for each asset class in the investment portfolio.

In some implementations, the set of investor data can include a risk aversion value that represents a risk preference for the investor and wherein each of the consumption utility function and the wealth utility function are calibrated using the risk aversion value.

In some implementations, the wealth utility function of the objective function can be calibrated by a time discount factor, wherein a value of the time discount factor affects when consumption begins during the time period T.

In some implementations, generating the post-annuitization utility values can include generating the post-annuitization utility values without adding, to the objective function, a separate element of guaranteed income resulting from the annual annuity payment resulting from purchasing the annuity and wherein generating the post-annuitization utility values without adding, to the objective function, the separate element of guaranteed income achieves computing resource efficiencies when generating the optimal capital allocation, the optimal consumption, and the optimal annuitization

The subject matter described in this specification can be implemented in particular embodiments to realize or more of the following advantages.

First, the techniques described in this specification can be used to compute an optimal annuitization simultaneously with the computation of the optimal capital allocation and consumption. In contrast, conventional dynamic programming-based approaches attempt to compute optimal capital allocation and optimal consumption, but generally fail to simultaneously also compute optimal annuitization.

Second, and relatedly, the techniques described in this specification compute the optimal consumption, capital allocation, and annuitization in a resource efficient manner that reduces the computational complexity of such optimization determinations in conventional systems, without reducing the accuracy of such optimization determinations. In conventional dynamic programming based-approaches, a significant number of computing resources are required to exhaustively analyze each possible combination of wealth, age, and guaranteed income to determine the optimal consumption and capital allocation. This resource consumption in conventional approaches is further exacerbated when the exhaustive search of the combinations is also used to evaluate the additional dimension(s) of annuitization (in addition to capital allocation and consumption). In contrast, the techniques described in this specification achieve significant resource efficiencies while maintaining accuracy of the optimization determinations with respect to consumption, allocation, and annuitization. As further described throughout this specification, the techniques described in this specification can accomplish this, e.g., by normalizing wealth by the guaranteed income into a range of discrete ratios (i.e., wealth to guaranteed income ratios), which reduces the number of dimensions (from three dimensions to two dimensions), and by utilizing a utility translation function that maps the post-annuitization utility values (for the discrete set of ratios) from year-to-year. This enables each period's utility values to be chained in the optimization determination over time.

Third, the techniques described in this specification can provide visualizations to investors, advisors, and/or other investment professionals to guide them on consumption, annuitization, and capital allocation decisions throughout retirement (or in other phases of life other than retirement).

Fourth, the techniques described in this specification can provide a holistic view of the solution space across all possible combinations of wealth and age dimensions. Such a visualization enables easy validation of the results, particularly in cases where the impact of the capital allocation, consumption, and annuity decisions on the utility function can be extremely small.

While generally described as computer-implemented software embodied on tangible media that processes and transforms the respective data, some or all of the aspects described in this specification may be computer-implemented methods or may further be included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF FIGURES

FIG. 1 is a block diagram illustrating an example system for optimizing consumption, capital allocation, and annuitization decisions for investors in retirement.

FIG. 2 is a block diagram illustrating the structure and operations of the optimization engine of the financial system server of FIG. 1

FIG. 3 shows an example user interface via which a user of a client device can provide investor data.

FIGS. 4A and 4B provide example user interfaces that showing graphical visualizations of the optimizations computed by the optimization model of the financial system server of FIG. 1.

FIG. 5 provides an example user interface showing graphical visualizations of optimal capital allocations that are customized for different mortality assumptions.

FIGS. 6A and 6B provide example user interfaces showing graphical visualizations with the results of a backtest with respect to capital allocations, guaranteed income, consumption, and annuity purchases.

FIG. 7 is a flow diagram of an example process for optimizing consumption, capital allocation, and annuitization decisions for investors in retirement.

FIG. 8 is block diagram of an example computer system.

Like reference numbers and designations in the various drawings indicate like elements.

### DETAILED DESCRIPTION

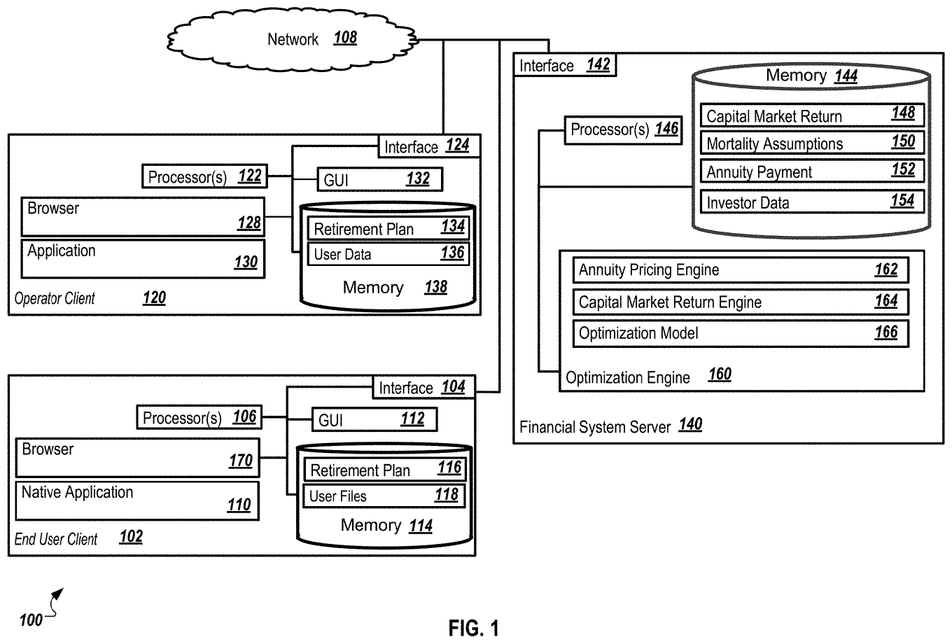

FIG. 1 is a block diagram illustrating an example system for optimizing consumption, capital allocation, and annuitization decisions for investors in retirement. Specifically, the illustrated system 100 includes or is communicably coupled with a financial system server 140, an end-user client device 102, an operator client device 120, and a network 108 (which can include a local area network (LAN), a wide area network (WAN), the Internet, or a combination thereof). Although shown separately, in some implementations, functionality of two or more systems, devices, or servers may be provided by a single system or server. In some implementations, the functionality of one illustrated system, server, or engine may be provided by multiple systems, servers, or engines, respectively.

An end-user client device 102 (also referred to herein as client device 102 or device 102) is an electronic device that is capable of requesting and receiving content over the network 108. The end-user client device 102 can include any client computing device such as a laptop/notebook computer, wireless data port, smart phone, personal data assistant (PDA), tablet computing device, one or more processors within these devices, or any other suitable processing device that can send and receive data over the network 108. For example, the end-user client device 102 can include, e.g., a computer that includes an input device, such as a keypad, touch screen, or other device that can accept user information, and an output device that conveys information, e.g., associated with the operation of the financial system server 140, or the client device itself, including digital data, visual information, or the GUI 122.

The end-user client device 102 typically includes one or more applications, such as a browser 170 or a native application 110, to facilitate sending and receiving of content over the network 108. Examples of content presented at a client device 102 include webpages, word processing documents, portable document format (PDF) documents, images, and videos.

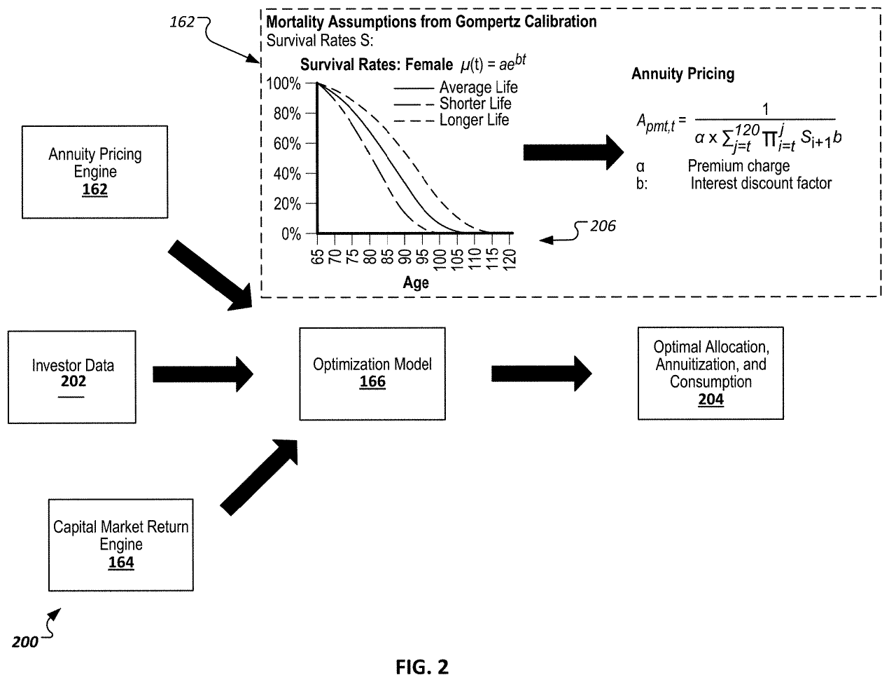

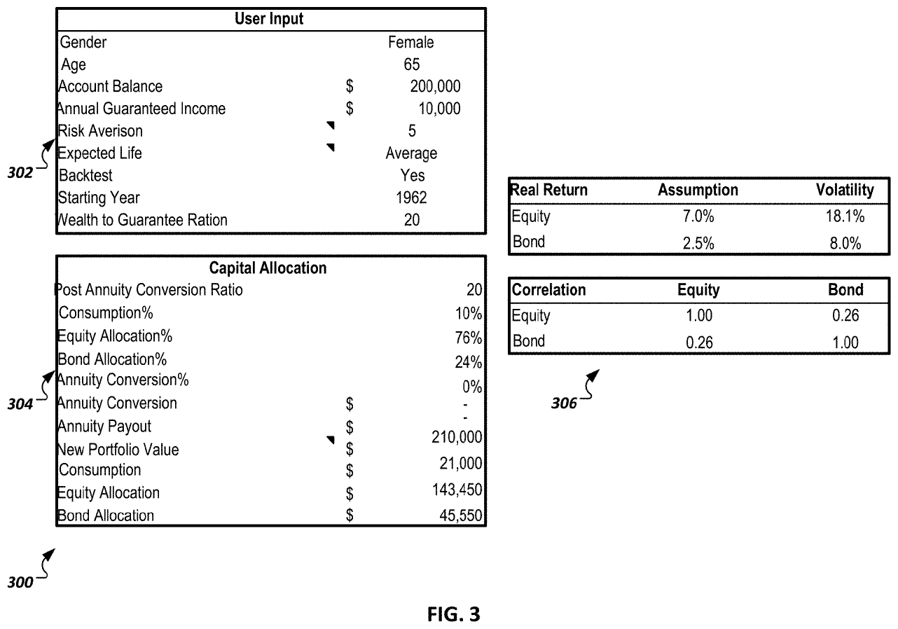

As described further with reference to FIGS. 2-7, an end user, who may be an individual investor, of the end-user client device 102 may desire to determine optimal consumption, capital allocation, and annuitization decisions for herself in retirement. To do that, the end user of the client device 102 can access the financial system's server 140 (e.g., directly or indirectly via an operator client device 120, which is described below) and obtain a web interface (an example of which is shown in FIG. 3 and described below) from the financial system server 140. The end user client device 102 provides this interface for display via its graphical user interface (GUI) 112.

On this interface, the end user can input certain investor data that is descriptive of the end user (e.g., current age, current cash/portfolio value, age, gender, etc.). Once the end user enters and submits this information on the interface, the optimization engine 160 of the financial system server 140 processes this data to determine the optimal consumption, capital allocation, and annuitization decisions for the end user in retirement (as further described with reference to FIGS. 2-7).

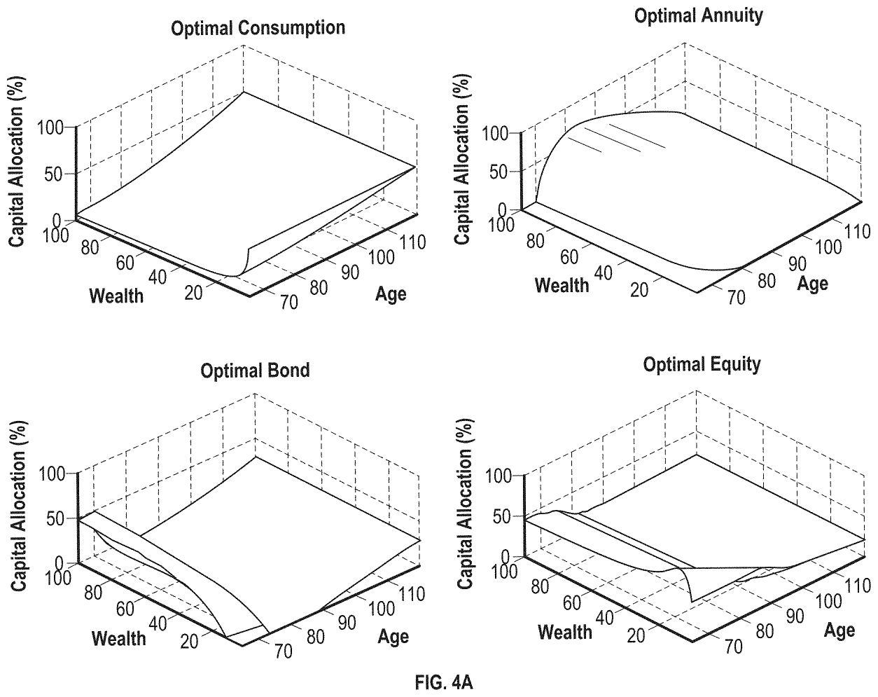

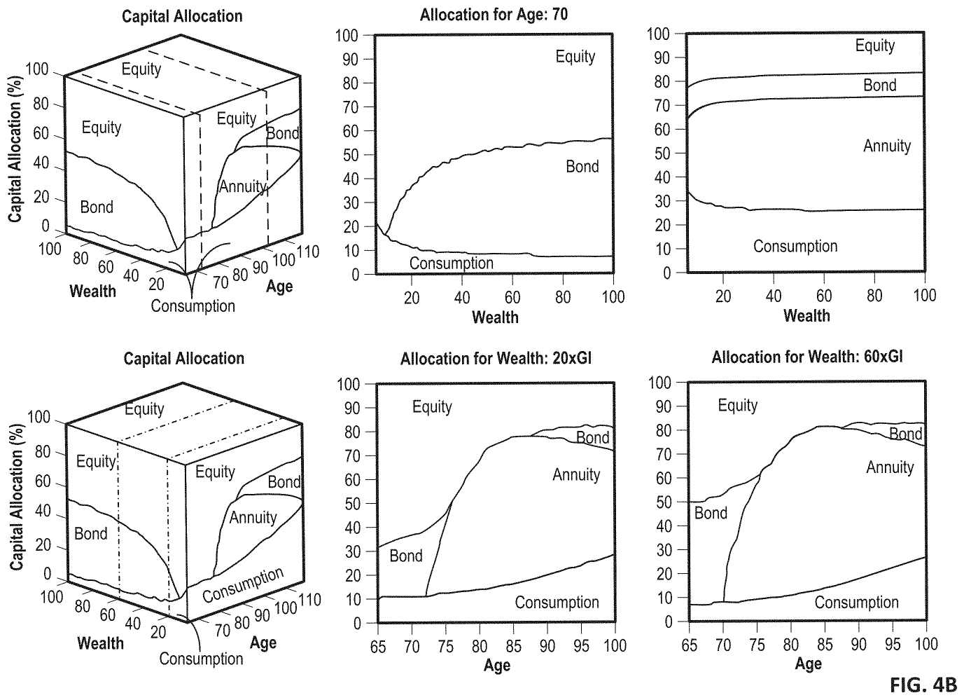

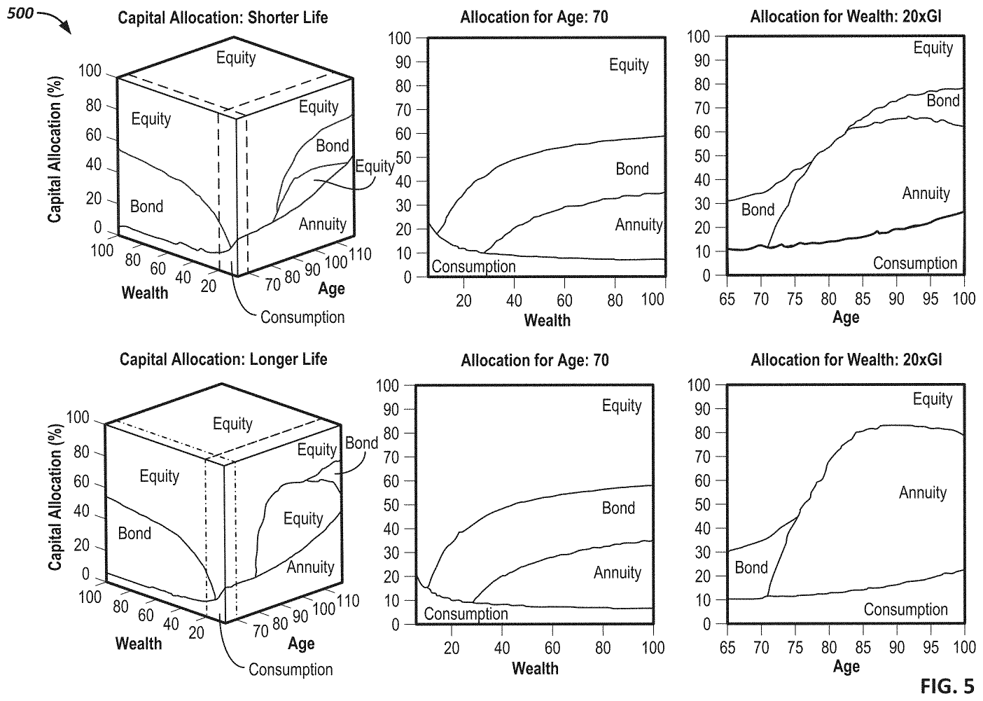

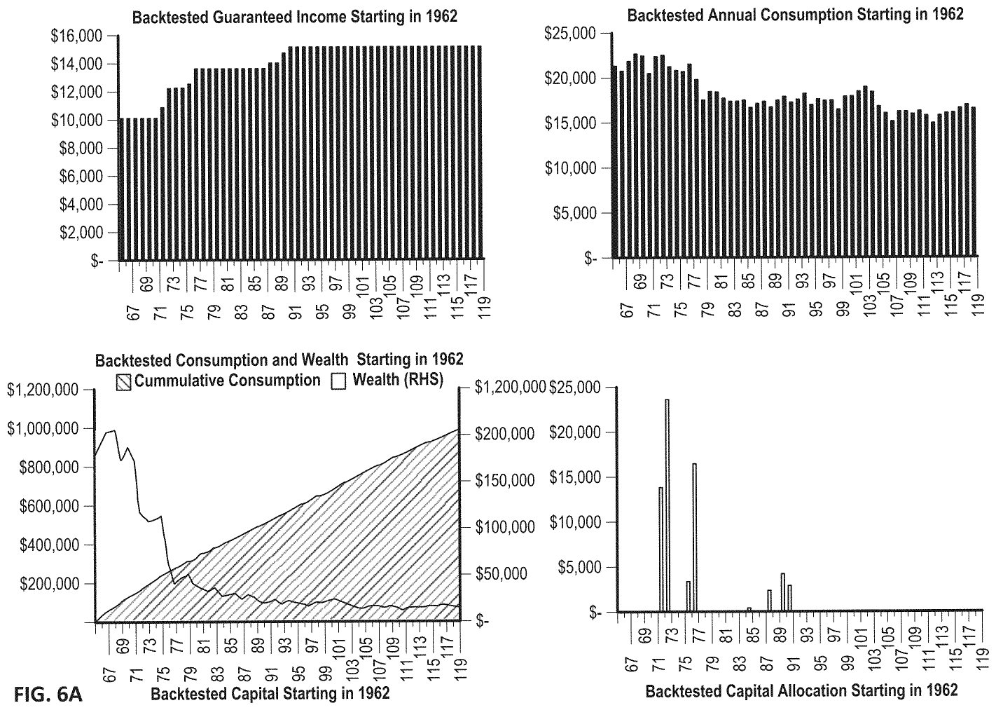

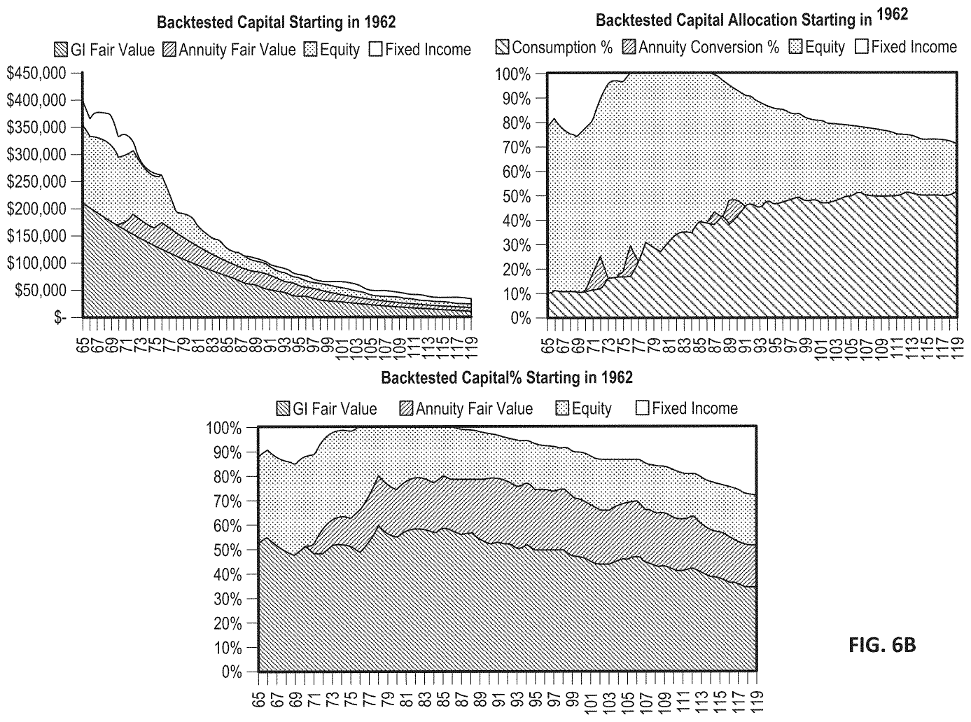

The financial system server 140 provides one or more web interfaces (e.g., as a portal or dashboard page associated with the retirement investor at the financial system server) to the end-user client device 102 (as shown in FIGS. 4-5) via which the determined optimal consumption, capital allocation, and annuitization values (and associated visualizations) for the end user in retirement are provided/displayed. In some implementations, the financial system server 140 can also provide one or more web interfaces (e.g., as a portal or dashboard page associated with the retirement investor) to the end-user client device 102 (as shown in FIG. 6) via which the results of a historical simulation/backtest are provided to illustrate the optimization model 166's performance using historical data and market performance.

In some implementation, the end user of the client device 102 can store the received optimization data (and associated visualizations) and/or backtest data (and associated visualizations) as retirement plan data 116 in the client device 102's memory 114 (along with the other user files 118 that may already be stored in the memory 114).

An operator client device 120 (also referred to here as client device 120 or device 120) is an electronic device that is capable of requesting and receiving content over the network 108. The operator client device 120 is generally a client device that is associated with a retirement planning or another financial/investment planning professional, e.g., an individual that is assisting an investor/user (e.g., end user of end-user client device 102) with retirement planning. The operator client device 120 can include any client computing device such as a laptop/notebook computer, wireless data port, smart phone, personal data assistant (PDA), tablet computing device, one or more processors within these devices, or any other suitable processing device that can send and receive data over the network 108. For example, the operator client device 120 can include, e.g., a computer that includes an input device, such as a keypad, touch screen, or other device that can accept user information, and an output device that conveys information, e.g., associated with the operation of the financial system server 140, or the client device itself, including digital data, visual information, or the GUI 132.

The operator client device 120 typically includes one or more applications, such as a browser 128 or a native application 130, to facilitate sending and receiving of content over the network 108. Examples of content presented at a client device 120 include webpages, word processing documents, portable document format (PDF) documents, images, and videos.

As with the end-user client device 102, a user of the operator device 120 may desire to determine optimal consumption, capital allocation, and annuitization decisions for a particular investor in retirement. The user of the operator device 120 can request and receive, from the financial system server 140, the optimal consumption, capital allocation, and annuitization decisions for the particular investor in retirement (in a similar manner as described with reference to the end user client device 102 and as further described with reference to FIGS. 2-7). In some implementations, the operator of the client device 120 can store the received data for the particular retirement investor as retirement plan data 134 in the client device 120's memory 138. In some implementations, the client device 120 can also store the user/investor data for a particular investor, based on which the optimization is performed. This data is stored as user data 136 (also referred to as investor data) in the memory 138 of the client device 120. In some implementations, the client device 120 can transmit the retirement plan data 134 to client device 102 (e.g., via an email to the end user of client device 102).

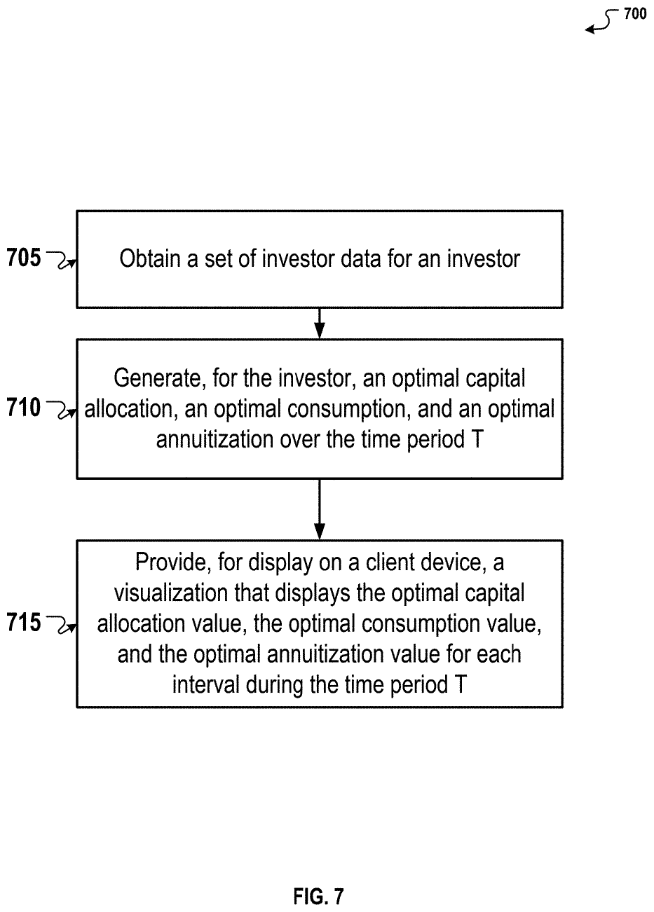

The financial server system 140 determines the optimal capital allocation, consumption, and annuitization for a retirement investor based on the investor data about the investor. As shown in FIG. 1 and as further described with reference to FIGS. 2 and 7, the financial server system includes an optimization model 166 that obtains a set of investor data (e.g., obtained from client devices 102 or 120, obtained from third party sources that store data about the investor, or obtained from a profile associated with the retirement investor at the financial system server 140) pertaining to the retirement investor. The set of investor data can include, e.g., an age of the investor, a guaranteed income of the investor over a period T, and a current wealth of the investor.

Using this investor data (as may be input, e.g., via the example interface shown in FIG. 3), the optimization model 166 of the financial system server 140 determines an optimal capital allocation value, an optimal consumption value, and an optimal annuitization value for each specified time interval (e.g., each year interval) during the period T (as further described below with reference to FIGS. 2 and 7).

The financial system server 140 provides, for display on the client devices 102 and/or 120, a visualization that displays the optimal capital allocation value, the optimal consumption value, and the optimal annuitization value for each yearly interval during the time period T (as shown and described with reference to FIGS. 3-6).

Although the above descriptions pertain to retirement investing and planning, a person of ordinary skill in the art will understand that the above-described techniques (as well as the techniques described in the rest of this specification) can also be applied to pre-retirement activities as well as any other types of investment planning activities.

Interfaces 104, 124, and 142 are used by the end-user client device 102, the operator client device 120, and the financial system server 140, respectively, for communicating with other systems in a distributed environment—including within the system 100—connected to the network 108. Generally, each of the interfaces 104, 124, and 142 include logic encoded in software and/or hardware in a suitable combination and operable to communicate with the network 108. More specifically, these interfaces can each include software supporting one or more communication protocols associated with communications such that the network 108 or interface's hardware is operable to communicate physical signals within and outside of the illustrated system 100.

The financial system server 140 includes one or more processors 146. Each processor 146 may be a central processing unit (CPU), a blade, an application specific integrated circuit (ASIC), a field-programmable gate array (FPGA), or another suitable component. Generally, each processor 146 executes instructions and manipulates data to perform the operations of the financial system server 140. Specifically, each processor 146 executes the functionality required to receive and respond to requests from the end-user client device 102 and the operator client device 120, for example.

The financial system server 140 includes memory 144. In some implementations, the financial system server 140 includes multiple memories. The memory 144 may include any type of memory or database module and may take the form of volatile and/or non-volatile memory including, without limitation, magnetic media, optical media, random access memory (RAM), read-only memory (ROM), removable media, or any other suitable local or remote memory component. The memory 144 may store various objects or data, including video files, metadata, caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the financial system server 140.

Additional aspects/components of the financial system server 140, including the optimization engine 160 and the types of data stored in the memory 144, are described below with reference to FIG. 2.

In general, the end-user client device 102 and the operator client device 120 each comprise an electronic computer device operable to receive, transmit, process, and store any appropriate data associated with the system 100 of FIG. 1. The end-user client device 102 and the operator client device 120 can each include one or more client applications (as described above). A client application is any type of application that allows the end-user client device 102 or the operator client device 120 to request and view content on a respective client device. In some implementations, a client application can use parameters, metadata, and other information received at launch to access a particular set of data from the financial system server 140. In some instances, a client application may be an agent or client-side version of the one or more enterprise applications running on an enterprise server (not shown).

The client device 102 and the operator client device 120 include one or more processor(s) 106 and processor(s) 122, respectively. Each of processor 106 or 122 may be a central processing unit (CPU), an application specific integrated circuit (ASIC), a field-programmable gate array (FPGA), or another suitable component. Generally, each processor 106 or 122 included in the end-user client device 102 or the operator client device 122 executes instructions and manipulates data to perform the operations of the end-user client device 102 or the operator client device 120, respectively. Specifically, each processor 106 or 122 included in the end-user client device 102 or the operator client device 120 executes the functionality required to send requests to the financial system server 140 and to receive and process responses from the financial system server 140.

GUIs 122 and 132 interface with at least a portion of the system 100 for any suitable purpose, including generating and/or displaying a visual representation (or data that provides a visual representation) provided by the financial system server 140. In particular, the GUI 122 and/or the GUI 132 may be used to view and navigate various Web pages. Generally, the GUI 122 and the GUI 132 provide a respective user with an efficient and user-friendly presentation of data provided by or communicated within the system 100. The GUI 122 and the GUI 132 may each comprise a plurality of customizable frames or views having interactive fields, pull-down lists, and buttons operated by the user. The GUI 122 and the GUI 132 each contemplate any suitable graphical user interface, such as a combination of a generic web browser, intelligent engine, and command line interface (CLI) that processes information and efficiently presents the results to the user visually.

Memory 114 and memory 124 included in the end-user client device 102 or the operator client device 120, respectively, may each include any memory or database module and may take the form of volatile or non-volatile memory including, without limitation, magnetic media, optical media, random access memory (RAM), read-only memory (ROM), removable media, or any other suitable local or remote memory component. The memory 168 and the memory 170 may each store various objects or data, including video files, metadata, data structures, user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the associated client device.

There may be any number of end-user client devices 102 and/or operator client devices 120 associated with, or external to, the system 100. For example, while the illustrated system 100 includes one end-user client device 102, alternative implementations of the system 100 may include multiple end-user client devices 102 communicably coupled to the financial system server 140 and/or the network 108, or any other number suitable to the purposes of the system 100. Additionally, there may also be one or more additional end-user client devices 102 external to the illustrated portion of system 100 that are capable of interacting with the system 100 via the network 108. Further, the term “client”, “client device,” and “user” may be used interchangeably as appropriate without departing from the scope of this disclosure. Moreover, while the end-user client device 102 and the operator client device 140 may be described in terms of being used by a single user, this specification contemplates that many users may use one computer, or that one user may use multiple computers.

FIG. 2 is a block diagram illustrating the structure and operations of the optimization engine 160 of the financial system server 140 of FIG. 1.

As shown in FIG. 1, the optimization engine 160 includes an optimization model 166, a capital market return engine 164, and an annuity pricing engine 162, each of which is described below.

As described with reference to FIG. 1, the financial system server 140 obtains the set of investor data, which can include the age, gender, and initial/current portfolio value for the investor's investment portfolio. As further described below, the optimization model 166 uses at least this data (as well as additional data, such as, e.g., annuity pricing data, data regarding capital market return assumptions and estimations).

The optimization model 166 determines the optimal capital allocation, consumption, and annuitization values 204 by chaining together two power utility functions: a utility function derived from consumption and another derived from bequest. These functions are shown below:

$$\begin{matrix}{U}_{c , t} = \frac{{{C}_{t}}^{1 - λ}}{1 - λ} & ( 1 ) \\ {U}_{bequest , t} = \frac{{{W}_{t + 1}}^{1 - λ}}{1 - λ} & ( 2 )\end{matrix}$$

In the above functions, U_{c,t} denotes the utility derived from consumption C at age t, and U_{bequest,t} denotes the utility of bequest. Also, in the above functions, λ is a risk-aversion parameter greater than 1 that is used to tailor to different risk preferences. Lambda is greater than 1 so that the utility function can be properly concave, representing a risk-averse investor. In addition, the shape of the power utility functions (equations (1) and (2)) is concave, implying that investors are risk-averse with a diminishing marginal utility for consumption.

To maximize lifetime utility, equations (1) and (2) are chained over age t, leading to the following recursive objective function, which is further described in the following paragraphs:

$${U}_{{W}_{i , t}} ( {C}_{i , t} , {K}_{i , t} , {AC}_{i , t} ) = {U}_{c , t} + β [ {S}_{t + 1} E ( {U}_{{W}_{i + 1}} \vert {W}_{i , t} ) + ( 1 - {S}_{t + 1} ) E ( {U}_{bequest , {W}_{t + 1}} \vert {W}_{i , t} ) ] \qquad ( 3 )$$

The optimization model 166 maximizes the above objective function for a range of normalized wealth values. The normalized wealth values, which are denoted by Wᵢ, are determined by normalizing wealth by guaranteed income (GI). As such, Wᵢ represents a particular wealth to guaranteed income (GI) ratio at level i, or in other words, it represents the wealth value in GI units for a particular level i. More simply, Wᵢ represents the investable retirement portfolio value, in units of GI, at level i.

In general, the range of Wᵢ can be discretized using a custom interval, with higher number of points in the lower range to improve accuracy and with each i representing one discretized value of W. In some implementations, Wᵢ values are evenly spaced in log scale, given that wealth is bound at zero (0) on the lower end and unbounded on the upper range. This results in more densely populated data points for the lower wealth range, which in turn helps improve the accuracy and computational efficiency of the optimization model 166. Because the marginal change in utility value is more drastic with lower values of wealth, a denser grid of data points enables approximation of the utility surface more accurately. As wealth gets higher, the density of the wealth grid can be gradually relaxed without compromising accuracy. In some implementations, the normalized wealth values can range from 1e-4 to 1000.

As described above, normalizing the wealth by guaranteed income achieves significant computational efficiencies in performing the optimization because it reduces the number of dimensions over which the optimization has to be performed. That's because, instead of performing the optimization over three dimensions (age, wealth, and guaranteed income) as in conventional solutions, the optimization here is performed over two dimensions: age and normalized wealth values. This significantly reduces the amount of computing resources that would otherwise be needed to perform the optimization.

Moreover, normalizing the wealth by guaranteed income enables simultaneously and efficiently modelling different combinations, e.g., as in the case of two (or more) investors that derive the same spending utility despite having different wealth and guaranteed incomes. For example, person A with $100,000 in wealth and $10,000 in guaranteed income derives the same utility as person B with $200,000 in wealth and $20,000 in guaranteed income. Specifically, spending $1 as person A is equivalent to spending $2 as person B.

In the above objective function, Cₜ, Kₜ and ACₜ represent decision variables that are optimized by the optimization model 166, and constitute the solution set of the optimization model 166. Consumption Cₜ specifies the investor's consumption and can be represented as a percent of the portfolio W at age t. The asset allocation weight vector Kₜ specifies the weights for the asset classes within the portfolio is allocated at age t and can be represented using a N×1 vector (e.g., a 3×1 vector) of asset weights representing the N (e.g., 3) asset classes included in the portfolio, such as, e.g., stocks, bonds, and cash. Annuity purchase/conversion ACₜ represents annuity purchase at time t and can be represented as a percent of the portfolio W.

In some implementations, the optimization model 166 also applies certain constraints on each of these variables for each applicable level i, such as e.g., (1) at age t, the asset allocation weight vector (Kₜ) is greater than zero (0) and the sum of the weights of each asset class in the vector adds up to one (1); (2) the consumption at age t (Cₜ) is greater than zero (0) but less than or equal to the normalized wealth (W_{i,t}) for age t; and (3) the annuity conversion (ACₜ) at age t is greater than or equal to 0 but less than or equal to the normalized wealth for time t. These constraints are mathematically represented as follows:

[symbol]

_{i,t}≥0,Σ [symbol] _{i,t}=1

Cᵢₜ≥0,C_{i,t}≤W_{i,t}

AC_{i,t}≥0,AC_{i,t}≤W_{i,t} (4)

Additionally, in the above objective function, β denotes the time discount factor and generally ranges from zero (0) to one (1). A larger value of β (e.g., 1) places more weight on future consumption, and encourages an investor to defer consumption towards later periods of retirement. Conversely, a smaller value of β (e.g., 0.0≤β≤0.5) places less weight on future consumption, and encourages consumption in earlier periods of retirement. Moreover, Sₜ₊₁ in the objective function denotes the conditional probability of surviving from age t to age t+1, and the optimization model 166 uses mortality assumptions for males and females in determining the conditional probability of survival year-after-year.

Further still, and as already described above, λ is a risk-aversion parameter that is used to calibrate the objective function and in particular, tailor the optimization to the specified risk preference for the investor.

In some implementations, the optimization model 166 can be subject to certain additional constraints, such as, e.g.: (1) upon an investor's death, the remaining portfolio wealth is consumed in its entirety with the same power utility function, (2) investors spend in a smoothed fashion from year-to-year in retirement, and (3) while the objective function is maximized over the range of normalized wealth values, that optimization/maximization is subject to no shorting or leverage constraints.

The optimization model 166 executes/solves the recursive objective function backwards from expected terminal age (e.g., t=120 years) to the age at the start of retirement (e.g., t=65 years). At each age t (between the terminal age and the age at the start of retirement), each of the utility functions in the objective function is computed, as further described below.

The optimization model 166 determines the expected utility of wealth value E[U_{W}_{ₜ}] for the year t by computing the probability P_{w}_{_{i,t}} weighted average of the t period utility values arising from the distribution of portfolio returns R_{port,t-1} on W_{i,t-1} for wealth level i. This is represented using the following equation:

E[U_{W}_{ₜ}|W_{i,t-1}]Σ_{w}_{_{i,t}}(P_{w}_{_{i,t}}U_{w}_{_{i,t}}) (5)

The optimization model 166 also determines the expected utility of bequest value E[U_{bequest,W}_{ₜ}] for the year t by computing the probability P_{w}_{_{i,t}} weighted average of the t period utility values arising from consuming the entire remaining wealth in a single period in cases of death in year t. In other words, the expected utility of bequest for the year t assumes that if an individual would die in year t, the entirety of his/her wealth is consumed within that year and its utility is computed in a similar manner to normal consumption utility. This is mathematically represented using the following equation:

E[U_{bequest,W}_{ₜ}|W_{i,t-1}]=Σ_{w}_{_{i,t}}(P_{w}_{_{i,t}}U_{bequest,w}_{_{i,t}}) (6)

The following paragraphs describe the computation of the wealth utility values.

As described above, the vector [symbol] ₜ specifies the capital allocation at age t across the various asset classes (e.g., stocks, bonds, cash, etc.) included in the investor's investment portfolio. In some implementations, [symbol] ₜ is represented mathematically as follows:

[symbol]

ₜ=[K_{stock,t},K_{bond,t},K_{cash,t}] (7)

In some implementations, the distribution of returns for each asset class in the portfolio are computed by the capital market return engine 164. In some implementations, the capital market return engine 164 computes/estimates the distribution of the assets' returns based on capital market return assumptions 148 stored in the memory 144 (or alternatively, the assumption data may be obtained by the capital market return engine from other sources, e.g., third party investment data aggregators). The capital market return assumptions provide expected market performance and link the portfolio value/wealth through each period. In particular, the capital market return assumptions provide assumptions on returns and correlations between assets, as well as allocations/weights chosen between equity and fixed income.

Example capital market return assumptions are provided in the table below, followed by an example computation performed by the capital market return engine to estimate the portfolio assets allocations and their respective returns:

| Asset | Mean mᵢ | Volatility\sqrt{V_{i,i}} | Correlation $\frac{{V}_{i , j}}{\sqrt{{V}_{i , i}} \sqrt{{V}_{j , i}}}$ |
|---|---|---|---|
| Equity | 7.00% | 18.10% | 0.14 |
| Fixed Income | 2.50% | 8.00% | 0.14 |

Assumes log normal distribution of returns (i.e., the natural log of linear returns follow a normal distribution with log mean μ(n×1) and covariance Σ(n×n) in the case of n assets modeled):

ln(1+R_{asset,t})˜ [symbol] (μ,Σ) (8)

$$\begin{matrix}{μ}_{i} = ln ( \frac{{( 1 + {m}_{i} )}^{2}}{\sqrt{{V}_{ii} + {( 1 + {m}_{i} )}^{2}}} ) & ( 9 ) \\ {\sum }_{i , j} = ln ( \frac{{V}_{i , j}}{( 1 + {m}_{i} ) ( 1 + {m}_{j} )} + 1 ) & ( 10 )\end{matrix}$$

Equations (8) to (10) mathematically represent conversion of a linear set of return (m, n×1 vector) and covariance (V, a n×n matrix) to their log-scale equivalent. Equation (8) states that the natural log of the linear returns on assets follow a normal distribution with mean μ and covariance Σ. Equation (9) represents the vector of expected annual asset returns on a log scale (as converted from the linear scale). Equation (10) provides, in a log scale, a matrix of asset covariance, as defined by the capital market assumptions. The computed capital market return for age t can be stored in memory 144 (e.g., as capital market returns data 148).

In some implementations, as part of the computation of the asset returns, the capital market return engine 164 uses Gauss-hermite quadrature to discretize the asset return distributions (which are otherwise normal distributions) while still being able to approximate the entire distribution. In alternative implementations, the capital market return engine 164 can discretize asset return distributions using discretization techniques other that Gauss-hermite quadrature.

Using the Gauss-hermite quadrature enables efficient discretization of the asset return distributions by capturing a large amount of information of the asset return distribution with fewer sampled data points, which in turn significantly reduces the expected computing resources used by the optimization model 166 for the optimization. The Gauss-hermite quadrature is represented using the following equations:

$$\begin{matrix}E [ f ( y ) ] \approx \frac{1}{\sqrt{π}} {\sum }_{i = 1}^{n} {w}_{i} f ( \sqrt{2} {σ x}_{i} + μ ) & ( 11 ) \\ x = \frac{y - μ}{\sqrt{2} σ} & ( 12 ) \\ w = \frac{{2}^{n - 1} n ! \sqrt{π}}{{{n}^{2} [ {H}_{n - 1} ( x ) ]}^{2}} & ( 13 )\end{matrix}$$

In equation (11), the expectation of function f (E[f(y)]) is provided, where f(y) represents a function for which y follows a normal distribution y˜N(μ,σ²). In equations (11) to (13), n is the number of sample points selected from the standard normal distribution. w in equation (13) is the weights for the associated sample points. E[f(y)] can be approximated efficiently with a high degree of precision with a small number of n, compared with traditional, computationally expensive Monte-Carlo simulations.

In some implementations, the distribution of the retirement portfolio's returns (R_{port,t-1}) at a particular time interval (age t−1) is computed by multiplying the return for each portfolio asset (as determined above—see equations (8) to (10)) with that asset's allocation at age t−1. This is mathematically represented using the following equation:

R_{port,t-1}= [symbol] ₜ× [symbol] _{asset,t-1} (14)

In equation (14), [symbol] _{asset,t′} represents the asset return for a particular asset class in the asset allocation vector. This computed capital market return for age t can be stored in memory 144 (e.g., as part of the capital market returns data 148).

The optimization model 166 further computes the guaranteed income at age t by summing all the predictable post-retirement income sources, which include, e.g., social security benefits and cash payouts from purchased annuities by age t (i.e., as of age t−1). This is mathematically represented using the following equation:

GIₜ=GIₜ₋₁+A_{pmt,t}, and GI₀=1 (15)

In the above equation, A_{pmt,t} represents the annuity payment at age t that results from an annuity conversion/purchase (which is represented as a percent of the portfolio W). In some implementations, the annuity payment data is obtained by the annuity pricing engine 162, e.g., from a third party source of such annuity information (e.g., third party annuity/insurance providers). Alternatively, the annuity pricing engine 162 can compute/estimate the annuity pricing/payment information using, e.g., the following equation that discounts a perpetual cash flow of $1 by estimated mortality rates and a discount rate:

$${A}_{pmt , t} = \frac{1}{α \times {\sum }_{j = t}^{120} {\prod }_{i = t}^{j} {S}_{i + 1} b} \qquad ( 16 )$$

In equation 16, α represents the premium charge, b represents the interest discount factor, and S represents the estimated survival rate, as determined by the mortality assumptions 150 (an example of which is depicted by reference 206 in FIG. 2). The computed annuity payment data for a particular age t can be stored in the memory 144 as part of the annuity payment data 152.

The optimization model 166 determines the wealth or portfolio value at age t by adding the various sources of income up to the age t and reducing that amount by the consumption and annuity conversion cost up to the age t. In some implementations, the optimization model 166 determines the wealth or portfolio value at age t by adding the wealth and guaranteed income up to age t (i.e., as of age t−1) and then reducing that amount by both the consumption and annuity purchases/conversions up to age t (i.e., as of age t−1). The resulting value is multiplied by the distribution of portfolio returns, as shown in equation (17) below, by (1+R_{port,t-1}), to obtain the wealth at age t. The distribution of portfolio returns is computed, e.g., as described above with reference to equation (14) and can be obtained from the capital market return data 144 previously stored in memory 144. These operations are mathematically represented using the following equation:

Wₜ*=(Wₜ₋₁+GIₜ₋₁−Cₜ₋₁−ACₜ₋₁)(1+R_{port,t-1}) (17)

Next, the optimization model 166 computes the wealth to guaranteed income ratio at age t (Wₜ) by reducing the wealth/portfolio value at age t (as determined in the preceding paragraph and per equation (17)) by the annuity conversion/purchase at age t and dividing the resulting amount by the annuity payment resulting from the annuity purchase at age t. This is mathematically represented using the following equation:

$${W}_{t} = \frac{{W}_{t}^{*} - {AC}_{t}}{1 + {A}_{pmt , t}} \qquad ( 18 )$$

The optimization model 166 multiplies the utility value for a wealth to guaranteed income ratio (as determined in equation 19) by the incremental annuity payment from the annuity purchase/conversion (AC) at age t to obtain a translation utility mapping function that determines post-annuitization utility values. In particular, the translation utility mapping function enables efficient and accurate calculations of utility values for different AC values without introducing a new GI dimension from annuity payment resulting from the annuity purchase. This translation utility mapping function is mathematically represented using the following function:

U(W_{i,t},ACₜ)=U(W_{i,t})(1+A_{pmt,t})^{1-λ} (19)

With annuity purchases, the guaranteed income will be increasing by the annuity payment each year and will not stay at a constant unit of 1. As such, in equation (19) above, the utility values for a post annuity-conversion wealth are mapped using the multiplier (1+A_{pmt,t})^{1-λ}. The 1−λ power term applies the proper scaling logic on the power utility value such that the utility values from multiple periods can be summed together with the correct scaling, which in turn enables computing optimal annuity conversion rate efficiently by utilizing the normalization of wealth to guaranteed income.

As depicted and described above, the optimal annuitization is determined by first normalizing wealth by the guaranteed income (also referred to as W/GI ratios), and then applying a translation utility mapping mechanism that adds annuitized income back into guaranteed income and re-normalizes each period's wealth (specified by the W/GI ratios) while preserving consistency in the utility values. As described above, these techniques reduce the number of dimensions (from 3 to 2), making these operations more computing resource efficient and numerically accurate than the brute-force approach presented by conventional dynamic programming-based approaches (as described above). The improved numerical accuracy and resource efficiency stems from the post-annuity conversion utility values being directly computed from one period to the next without the need of discretization in an additional dimension. Without such a dimensional reduction, the annuity already owned would have to be processed as a separate, discretized dimension similar to wealth and age, which increases the computational time exponentially and results in a loss of accuracy as discretized points will need to be interpolated back to a continuous surface after accounting for all use cases.

FIG. 3 provides an example user interface via which a user of a client device 102 or 120 can provide investor data that can be used by the financial system server 140 (and in particular, the optimization engine 160) in computing the optimal capital allocation, consumption, and annuitization.

In the interface shown in FIG. 3, the user of a client device 102 or 120 can enter data in the fields in the User Input table 302. As shown, the entered data can include some or all of the the following data about the investor: (1) investor age; (2) investor gender; (3) investor's current account balance; (4) investor's expected annual guaranteed income; and (5) investor's expected life expectancy.

In some implementations, the investor can choose to run a backtest (by entering “Yes” for the “Backtest” field) and specify a starting year for the backtest (in the “Starting Year” field). The backtest is a historical simulation that uses actual market performance for a specified timeframe (e.g., starting from the specified year in the “Starting Year” field to the present time) to estimate a retirement portfolio performance. When the user of client device 102 or 120 selects to perform a backtest, the optimization model 166 performs its processing in the same manner as described with reference to FIG. 2; however, instead of using capital market return assumptions as described above in FIG. 2, the backtest uses actual, historical market returns and performance for the selected backtest period. In some implementations, a user of client device 102 or 120 can choose to run the model to simultaneously perform a backtest as well as generate expected optimizations using the capital market return assumptions.

The interface shown in FIG. 3 also includes a capital allocation table 304. This table specifies the capital allocations (as a percent and in actual dollar (or other currency) values), the post annuity conversion ratio, the total current portfolio value, and the annual consumption amount. In some implementations, the allocations and consumption values/percentages can be specified by the user of the client device 102 or 120. In some implementations, these values are determined by the optimization model for the current year and using the current portfolio value.

The interface shown in FIG. 3 also includes assumptions 306 regarding the asset return, asset volatility, and correlation between asset classes (as described above with reference to FIG. 2).

The user input data 302, the capital allocation values 304, and the assumptions data 306 are provided to the optimization model 166 as part of the optimization performed by the model 166 (as described above with reference to FIG. 2).

FIGS. 4A and 4B provide example user interfaces that show graphical visualizations of the optimizations computed by the optimization model 166 of the financial system server 140 of FIG. 1.

In particular, FIG. 4A provides an example user interface showing graphical visualizations of the optimal consumption, annuity purchase, equity, and bond allocations by age and wealth (as computed by the optimization model, which is described above with reference to FIGS. 2 and 3).

FIG. 4B provides an example user interface showing capital allocations at different ages (e.g., at age 70 and age 100) and at different wealth to GI ratios (e.g., W/GI of 20 versus 60).

FIG. 5 provides an example user interface showing graphical visualizations of optimal capital allocations that are customized for different mortality assumptions (e.g., a shorter life span versus a longer life span).

FIGS. 6A and 6B provide example user interfaces with graphical visualizations showing the results of the backtest with respect to capital allocations, guaranteed income, consumption, and annuity purchases.

FIG. 7 is a flow diagram of an example process 700 for optimizing consumption, capital allocation, and annuitization decisions for investors in retirement. Operations of process 700 are described below as being performed by the components of the system described and depicted in FIGS. 1-2. Operations of the process 700 are described below for illustration purposes only. Operations of the process 700 can be performed by any appropriate device or system, e.g., any appropriate data processing apparatus. Operations of the process 700 can also be implemented as instructions stored on a non-transitory computer readable medium. Execution of the instructions causes one or more data processing apparatus to perform operations of the process 700.

The optimization model 166 obtains a set of investor data for an investor (at 705). As described above with reference to FIGS. 1 and 2, in some implementations, an investor at client device 102 (or an operator at client device 120) submits, to the financial system server 140, a set of investor data corresponding to an investor via a user interface provided for display at the client device 102 or 120. The set of investor data can include, e.g., (1) the investor's age, (2) the investor's gender; (3) the investor's current/initial investment portfolio value/account balance, (4) the investor's expected annual guaranteed income over a time period T (where T can be the length of the retirement); and (5) the investor's expected life expectancy. The optimization model 166 obtains this set of investor data upon it being received by the financial server system 140 from the client device 102 or 120 (e.g., based on the user's inputs to an interface such as the one shown in FIG. 3). Alternatively, in some implementations, the optimization model 166 obtains this set of investor data 154 from the memory 144 of the financial system server 140. In such implementations, the set of investor data may previously have been provided by the investor, e.g., during an account set up for the investor at the financial system server 140.

The optimization model 166 generates, for the investor, an optimal capital allocation, an optimal consumption, and an optimal annuitization over the time period T (at 710). In some implementations, and as described above with reference to FIGS. 1 and 2, the optimization model 16 generates, for the investor, the optimal capital allocation, the optimal consumption, and the optimal annuitization over the time period T by maximizing an objective function. This objective function, which is further described with reference to FIG. 2 and an example of which is shown in equation (3) above, specifies (1) a consumption utility function that computes a utility derived from consumption of wealth of the investor at each specified time interval (e.g., for each year) during the time period T (e.g., during retirement) and (2) a wealth utility function that computes utility derived from the wealth of the investor for each specified time interval during the time period T.

As described above with reference to FIG. 2, the wealth utility function computes post-annuitization utility values for a set of wealth-to-guaranteed income ratios for each specified time interval during the time period T. As described above with reference to FIG. 2, the optimization model 166 achieves significant computing resource efficiencies by computing the post-annuitization utility values without introducing a new guaranteed income (GI) dimension from the annuity payment resulting from the annuity purchase.

As described above with reference to FIG. 2, the optimization model 166 determines post-annuitization wealth utility values by performing the following steps at each specified time interval (t) during the time period T: (1) determining a total portfolio value (Wₜ) of the investor; (2) determining an annuity purchase cost (ACₜ) for purchasing an annuity and an annual annuity payment (1+A_{pmt,t}) resulting from purchasing the annuity; (3) reducing the total portfolio value by the annuity purchase cost (Wₜ−ACₜ) to obtain a new total portfolio value; (4) generating a wealth to guaranteed income (W/GI) ratio, e.g., by dividing the new total portfolio value by the annual annuity payment

$$( \frac{{W}_{t}^{*} - {AC}_{t}}{1 + {A}_{pmt , t}} ) ;$$

and (5) generating me post-annuitization utility values by determining the utility of wealth values for the generated wealth to guaranteed income ratio and multiplying this value by the incremental annuity payment from the annuitization, which is represented by U(W_{i,t}, ACₜ)=U(W_{i,t})(1+A_{pmt,t})^{1-λ}.

The total portfolio value for a particular time interval (t), as described in the previous paragraph, can be determined by computing/determining the following values for a time interval immediately preceding the particular time interval (t−1): (1) determining a total income for the investor by combining (e.g., summing) a portfolio value (Wₜ₋₁) for the investment portfolio and a guaranteed income (GIₜ₋₁) for the investor; (2) reducing the total income by an amount consumed by the investor (Cₜ₋₁) and the annuitization purchase cost (ACₜ₋₁) to obtain an updated total income (Wₜ₋₁+GIₜ₋₁−Cₜ₋₁−ACₜ₋₁); (3) generating a return for the investment portfolio (1+R_{port,t-1}); and (4) computing the total portfolio value by multiplying the updated total income by the return for the investment portfolio (Wₜ*=(Wₜ₋₁+GIₜ₋₁−Cₜ₋₁−ACₜ₋₁)(1+R_{port,t-1})). These computations are further described above with reference to FIG. 2.

In the preceding paragraph, generating the return for the investment portfolio (1+R_{port,t-1}) can include determining a discretized distribution of returns for each asset class in the investment portfolio, which is determined by applying Gauss-hermite quadrature to a set of discretized points in distribution of returns for each asset class in the investment portfolio (as further described above with reference to FIG. 2).

Returning to FIG. 3, the optimization model 166 provides, for display on the client device 102 and/or 120, a visualization that displays the optimal capital allocation, the optimal consumption, and the optimal annuitization for each interval (e.g., for each year) during the time period T (at 715). As described with reference to FIGS. 1 and 2, upon determining the optimal capital allocation, the optimal consumption, and the optimal annuitization for each interval during the time period T, the optimization model 166 generates visualization(s) of this data (e.g., as shown in FIGS. 4-5) and visualization(s) of any backtested data (e.g., as shown and described with reference to FIGS. 1 and 6). The optimization model 166 provides this data and the associated visualization(s) for display on a client device (e.g., client device 102 or 120, which initially requested the optimization).

In summary, and as described in greater detail above, the optimization techniques described in this specification, and in particular, the optimization with respect to annuitization described herein, are determined by first normalizing wealth by the guaranteed income (also referred to as W/GI ratios), and then applying a translation utility mapping mechanism that adds annuitized income back into guaranteed income and re-normalizes each period's wealth (specified by the W/GI ratios) while preserving consistency in the utility values. As described above, these techniques reduce the number of dimensions (from three to two) over which the optimization needs to be performed, making the resulting optimization processing more computing resource efficient (relative to prior techniques that would have required significant number of computing resources to process every possible combination of the three). As such, the techniques described herein improve the functioning of the computing device (e.g., the financial server system 140) by enabling the system to perform optimization across capital allocations, consumption, and annuitization in a resource efficient manner, which results in faster computation time and yet does not sacrifice the optimization for annuitization (as was the case in conventional solutions that avoided optimizing annuitization decisions due to the added computational complexity from optimizing over that additional variable). As such, the techniques described herein provide a technology based solution for optimizing retirement/investing decisions and overcomes the disadvantages of conventional optimization techniques that were resource intensive, computationally complex, and generally unable to perform the optimization for annuitization decisions in addition to capital allocation and consumption.

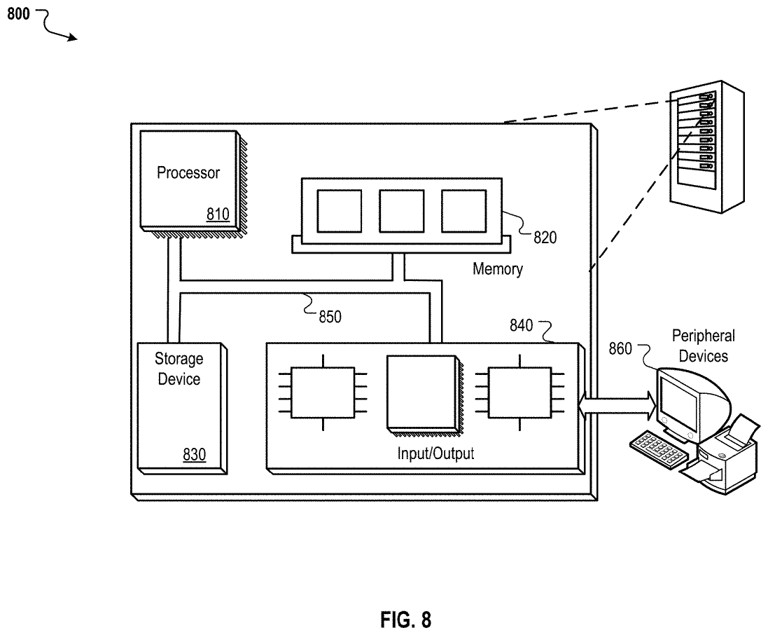

FIG. 8 is block diagram of an example computer system 800 that can be used to perform operations described above. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In some implementations, the processor 410 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In some implementations, the memory 820 is a volatile memory unit. In another implementation, the memory 820 is a non-volatile memory unit.

The storage device 830 is capable of providing mass storage for the system 800. In some implementations, the storage device 830 is a computer-readable medium. In various different implementations, the storage device 830 can include, for example, a hard disk device, an optical disk device, a storage device that is shared over a network by multiple computing devices (e.g., a cloud storage device), or some other large capacity storage device.

The input/output device 840 provides input/output operations for the system 800. In some implementations, the input/output device 840 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 860. Other implementations, however, can also be used, such as mobile computing devices, mobile communication devices, set-top box television client devices, etc.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a computer or a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Similarly, the term “computer” or “computing device” encompasses any suitable data processing apparatus. Indeed, the financial system server 140 and the client devices 102 and 120 can be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the financial system server 140 and the client devices 102 and 120 may be adapted to execute any operating system, including Linux, UNIX, Windows, Mac OS®, Java™, Android™, iOS or any other suitable operating system. According to one implementation, the financial system server 140 may also include or be communicably coupled with an e-mail server, a Web server, a caching server, a streaming data server, and/or other suitable server.

In this specification, the different functions can also be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method, comprising:
obtaining a set of investor data for an investor, including (1) an age of the investor, (2) an annual guaranteed income of the investor over a time period T, and (3) an initial portfolio value of an investment portfolio for the investor;
generating, using a model and the set of investor data, an optimal capital allocation, an optimal consumption, and an optimal annuitization for the investor over the time period T, by maximizing an objective function, wherein:
the objective function specifies (1) a consumption utility function that computes a utility derived from consumption of wealth of the investor at each specified time interval during the time period T and (2) a wealth utility function that computes utility derived from the wealth of the investor for each specified time interval during the time period T, wherein the wealth utility function computes post-annuitization utility values for a set of ratios for each specified time interval during the time period T and wherein the set of ratios is defined by normalizing different wealth values by different guaranteed income values; and
providing, for display on a client device, a visualization that displays the optimal capital allocation value, the optimal consumption value, and the optimal annuitization value for the investor for each interval during the time period T.

2. The computer-implemented method of claim 1, further comprising:
for each specified time interval during the time period T:
determining a total portfolio value for the investment portfolio;
determining an annuity purchase cost for purchasing an annuity and an annual annuity payment resulting from purchasing the annuity;
reducing the total portfolio value by the annuity purchase cost to obtain a new total portfolio value; and
generating a wealth-to-guaranteed income ratio (W/GI) using the new total portfolio value and the annual annuity payment.

3. The computer-implemented method of claim 2, further comprising:
generating wealth utility values based on the new total portfolio value; and
generating the post-annuitization utility values using the wealth utility values and annual annuity payment.

4. The computer-implemented method of claim 2, wherein determining the total portfolio value of the investor, comprises:
for a time interval immediately preceding the specified time interval:
determining a total income by combining a current portfolio value for the investment portfolio and a guaranteed income for the investor;
generating an updated total income by reducing the total income by an amount specifying income consumed by the investor and the annuity purchase cost;
generating a return for the investment portfolio; and
computing the total portfolio value by multiplying the updated total income by the return for the investment portfolio.

5. The computer-implemented method of claim 4, wherein generating the return for the investment portfolio for the time interval immediately preceding the specified time interval, comprises:
generating a discretized distribution of returns for each asset class in the investment portfolio, wherein the discretized distribution of returns is generated by applying Gauss-hermite quadrature to a set of discretized points in a distribution of returns for each asset class in the investment portfolio.

6. The computer-implemented method of claim 1, wherein the set of investor data comprises a risk aversion value that represents a risk preference for the investor and wherein each of the consumption utility function and the wealth utility function are calibrated using the risk aversion value.

7. The computer-implemented method of claim 1, wherein the wealth utility function of the objective function is calibrated by a time discount factor, wherein a value of the time discount factor affects when consumption begins during the time period T.

8. The computer-implemented method of claim 3, wherein generating the post-annuitization utility values comprises generating the post-annuitization utility values without adding, to the objective function, a separate element of guaranteed income resulting from the annual annuity payment resulting from purchasing the annuity and wherein generating the post-annuitization utility values without adding, to the objective function, the separate element of guaranteed income achieves computing resource efficiencies when generating the optimal capital allocation, the optimal consumption, and the optimal annuitization.

9. A system comprising at least one processor and at least one non-transitory memory coupled to the at least one processor, wherein the at least one non-transitory memory storing programming instructions, that upon execution by the least one processor, perform operations comprising:
obtaining a set of investor data for an investor, including (1) an age of the investor, (2) an annual guaranteed income of the investor over a time period T, and (3) an initial portfolio value of an investment portfolio for the investor;
generating, using a model and the set of investor data, an optimal capital allocation, an optimal consumption, and an optimal annuitization for the investor over the time period T, by maximizing an objective function, wherein:
the objective function specifies (1) a consumption utility function that computes a utility derived from consumption of wealth of the investor at each specified time interval during the time period T and (2) a wealth utility function that computes utility derived from the wealth of the investor for each specified time interval during the time period T, wherein the wealth utility function computes post-annuitization utility values for a set of ratios for each specified time interval during the time period T and wherein the set of ratios is defined by normalizing different wealth values by different guaranteed income values; and
providing, for display on a client device, a visualization that displays the optimal capital allocation value, the optimal consumption value, and the optimal annuitization value for the investor for each interval during the time period T.

10. The system of claim 9, wherein the at least one non-transitory memory storing programming instructions, that upon execution by the least one processor, perform operations further comprising:
for each specified time interval during the time period T:
determining a total portfolio value for the investment portfolio;
determining an annuity purchase cost for purchasing an annuity and an annual annuity payment resulting from purchasing the annuity;
reducing the total portfolio value by the annuity purchase cost to obtain a new total portfolio value; and
generating a wealth-to-guaranteed income ratio (W/GI) using the new total portfolio value and the annual annuity payment.

11. The system of claim 10, wherein the at least one non-transitory memory storing programming instructions, that upon execution by the least one processor, perform operations further comprising:
generating wealth utility values based on the new total portfolio value; and
generating the post-annuitization utility values using the wealth utility values and annual annuity payment.

12. The system of claim 10, wherein determining the total portfolio value of the investor, comprises:
for a time interval immediately preceding the specified time interval:
determining a total income by combining a current portfolio value for the investment portfolio and a guaranteed income for the investor;
generating an updated total income by reducing the total income by an amount specifying income consumed by the investor and the annuity purchase cost;
generating a return for the investment portfolio; and
computing the total portfolio value by multiplying the updated total income by the return for the investment portfolio.

13. The system of claim 12, wherein generating the return for the investment portfolio for the time interval immediately preceding the specified time interval, comprises:
generating a discretized distribution of returns for each asset class in the investment portfolio, wherein the discretized distribution of returns is generated by applying Gauss-hermite quadrature to a set of discretized points in a distribution of returns for each asset class in the investment portfolio.

14. The system of claim 9, wherein the set of investor data comprises a risk aversion value that represents a risk preference for the investor and wherein each of the consumption utility function and the wealth utility function are calibrated using the risk aversion value.

15. The system of claim 9, wherein the wealth utility function of the objective function is calibrated by a time discount factor, wherein a value of the time discount factor affects when consumption begins during the time period T.

16. The system of claim 11, wherein generating the post-annuitization utility values comprises generating the post-annuitization utility values without adding, to the objective function, a separate element of guaranteed income resulting from the annual annuity payment resulting from purchasing the annuity and wherein generating the post-annuitization utility values without adding, to the objective function, the separate element of guaranteed income achieves computing resource efficiencies when generating the optimal capital allocation, the optimal consumption, and the optimal annuitization.

17. A non-transitory computer readable medium storing instructions that, when executed by one or more data processing apparatus, cause the one or more data processing apparatus to perform operations comprising:
obtaining a set of investor data for an investor, including (1) an age of the investor, (2) an annual guaranteed income of the investor over a time period T, and (3) an initial portfolio value of an investment portfolio for the investor;
generating, using a model and the set of investor data, an optimal capital allocation, an optimal consumption, and an optimal annuitization for the investor over the time period T, by maximizing an objective function, wherein:
the objective function specifies (1) a consumption utility function that computes a utility derived from consumption of wealth of the investor at each specified time interval during the time period T and (2) a wealth utility function that computes utility derived from the wealth of the investor for each specified time interval during the time period T, wherein the wealth utility function computes post-annuitization utility values for a set of ratios for each specified time interval during the time period T and wherein the set of ratios is defined by normalizing different wealth values by different guaranteed income values; and
providing, for display on a client device, a visualization that displays the optimal capital allocation value, the optimal consumption value, and the optimal annuitization value for the investor for each interval during the time period T.

18. The non-transitory computer readable medium of claim 17, wherein the instructions, when executed by one or more data processing apparatus, cause the one or more data processing apparatus to perform operations further comprising:
for each specified time interval during the time period T:
determining a total portfolio value for the investment portfolio;
determining an annuity purchase cost for purchasing an annuity and an annual annuity payment resulting from purchasing the annuity;
reducing the total portfolio value by the annuity purchase cost to obtain a new total portfolio value; and
generating a wealth-to-guaranteed income ratio (W/GI) using the new total portfolio value and the annual annuity payment.

19. The non-transitory computer readable medium of claim 18, wherein the instructions, when executed by one or more data processing apparatus, cause the one or more data processing apparatus to perform operations further comprising:
generating wealth utility values based on the new total portfolio value; and
generating the post-annuitization utility values using the wealth utility values and annual annuity payment.

20. The non-transitory computer readable medium of claim 18, wherein determining the total portfolio value of the investor, comprises:
for a time interval immediately preceding the specified time interval:
determining a total income by combining a current portfolio value for the investment portfolio and a guaranteed income for the investor;
generating an updated total income by reducing the total income by an amount specifying income consumed by the investor and the annuity purchase cost;
generating a return for the investment portfolio; and
computing the total portfolio value by multiplying the updated total income by the return for the investment portfolio.
